(19) United States
(12) Patent Application Publication
(10) Pub. No.: US 2013/0114883 A1
(43) Pub. Date: May 9, 2013

(54) APPARATUS FOR EVALUATING VOLUME AND METHOD THEREOF

(71) Applicants: Ludovic Angot, Hsinchu City (TW); Chuan-Chung Chang, Hsinchu County (TW); Yung-Lin Chen, Yunlin County (TW)

(72) Inventors: Ludovic Angot, Hsinchu City (TW); Chuan-Chung Chang, Hsinchu County (TW); Yung-Lin Chen, Yunlin County (TW)

(73) Assignee: INDUSTRIAL TECHNOLOGY RESEARCH INSTITUTE, Hsinchu (TW)

(21) Appl. No.: 13/550,624

(22) Filed: Jul. 17, 2012

Related U.S. Application Data
(60) Provisional application No. 61/555,490, filed on Nov. 4, 2011.

(51) Int. Cl. G06K 9/00

(52) U.S. Cl. 382/154

(57) ABSTRACT

An apparatus for evaluating a volume of an object and a method thereof are provided. The provided apparatus and the method can precisely evaluate the volume of the object with a single camera, and the required evaluation time is short. Accordingly, shipping companies can utilize the most appropriate container or cargo space for each object to deliver, thereby reducing operation costs and optimizing the transportation fleet.

### CROSS-REFERENCE TO RELATED APPLICATION

This application claims the priority benefits of U.S. provisional application Ser. No. 61/555,490, filed on Nov. 4, 2011. The entirety of the above-mentioned patent application is hereby incorporated by reference herein and made a part of this specification.

### BACKGROUND

1. Technical Field

The disclosure relates to an apparatus for evaluating a volume of an object and a method thereof.

2. Related Art

In order to optimize the cargo space and the transportation fleet, shipping companies wanting to reduce operation costs need to know with precision the volume of each object destined for delivery. Several methods exist to evaluate the volume of an object, some are based on ultrasonic sensors, while others require the use of multiple cameras.

### SUMMARY

An exemplary embodiment of the disclosure provides an apparatus for evaluating a volume of an object. The apparatus includes an image acquisition unit and a processing unit. The image acquisition unit is positioned at a first distance from a bottom surface of the object and is configured for acquiring at least an acquired image of the object. The processing unit is coupled to the image acquisition unit and is configured for processing the acquired image to calculate a blur metric of an image pattern in the acquired image, and to obtain a normalized blur metric value for evaluating a first dimension of the object. The processing unit further processes the acquired image to determine an image portion of the acquired image, in which the image portion includes a top surface of the object. Moreover, the processing unit performs an edge detection operation on the image portion to obtain a second dimension information and a third dimension information corresponding to the image portion. Additionally, the processing unit evaluates a second dimension and a third dimension of the object according to the second dimension information, the third dimension information, and a corresponding magnification ratio. Accordingly, the processing unit calculates the volume of the object according to the first dimension, the second dimension, and the third dimension.

Another exemplary embodiment of the disclosure provides a method for evaluating a volume of an object. The method includes positioning an image acquisition unit at a first distance from a bottom surface of the object and configuring the image acquisition unit to acquire at least an acquired image of the object. The acquired image is then processed to calculate a blur metric of an image pattern in the acquired image, and to obtain a normalized blur metric value for evaluating a first dimension of the object. The acquired image is further processed to determine an image portion of the acquired image, in which the image portion includes a top surface of the object. An edge detection process is performed on the image portion to obtain a second dimension information and a third dimension information corresponding to the image portion. Moreover, a second dimension and a third dimension of the object are evaluated according to the second dimension information, the third dimension information, and a corresponding magnification ratio. The volume of the object is calculated according the first dimension, second dimension, and the third dimension.

Several exemplary embodiments accompanied with figures are described in detail below to further describe the disclosure in detail.

### BRIEF DESCRIPTION OF THE DRAWINGS

The accompanying drawings constituting a part of this specification are incorporated herein to provide a further understanding of the disclosure. Here, the drawings illustrate embodiments of the disclosure and, together with the description, serve to explain the principles of the disclosure.

FIG. 1 is a diagram of an apparatus for evaluating a volume of an object.

FIG. 2A is a side-view diagram of the object in FIG. 1; and FIG. 2B is a top-view diagram of the object in FIG. 1.

FIG. 3 is a diagram of an acquired image acquired by an image acquisition unit.

FIG. 4 is a configuration diagram of the image acquisition unit.

FIG. 5 is a corresponding relationship diagram between a plurality of normalized blur metric values BM and a plurality of measured distances hmea.

FIG. 6 is a flow chart of a method for evaluating a volume of an object.

### DETAILED DESCRIPTION OF DISCLOSED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

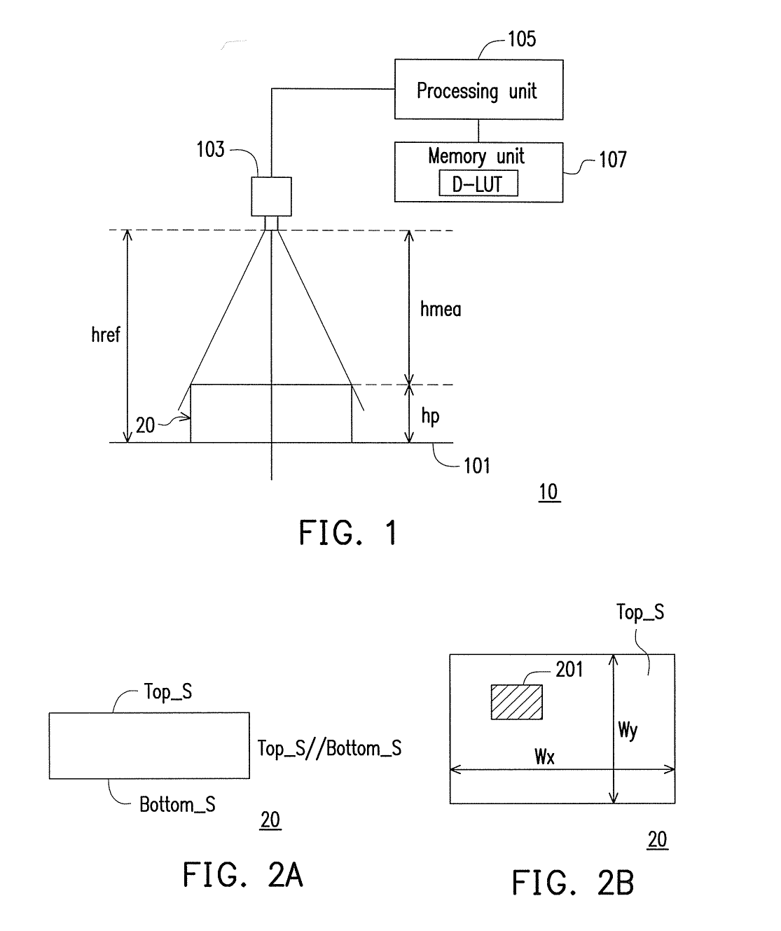

FIG. 1 is a diagram of an apparatus 10 for evaluating a volume of an object 20. Referring to FIG. 1, the apparatus 10 includes an image acquisition unit 103, a processing unit 105, and a memory unit 107. In the exemplary embodiment, the object 20 may be a parcel, a package, or a product in an assembly line, although the disclosure is not limited thereto. The object 20 may be rested on a reference surface 101, which can be a conveyor belt, although the object 20 is not limited to being placed on any particular surface in the disclosure. As shown in FIGS. 2A and 2B, a top surface Top_S and a bottom surface Bottom_S of the object 20 may be substantially parallel, although the object 20 is not required to have substantially parallel top and bottom surfaces. The top surface Top_S of the object 20 has an image pattern 201, such as a two-dimensional (2D) barcode (e.g. Quick Response (QR) code), but the disclosure is not limited thereto. Any image patterns having a plurality of elements arranged regularly, randomly, or pseudo-randomly can be used, with the elements having the same size or different size, as long as the elements in the image pattern 201 can be resolved by the image acquisition unit 103.

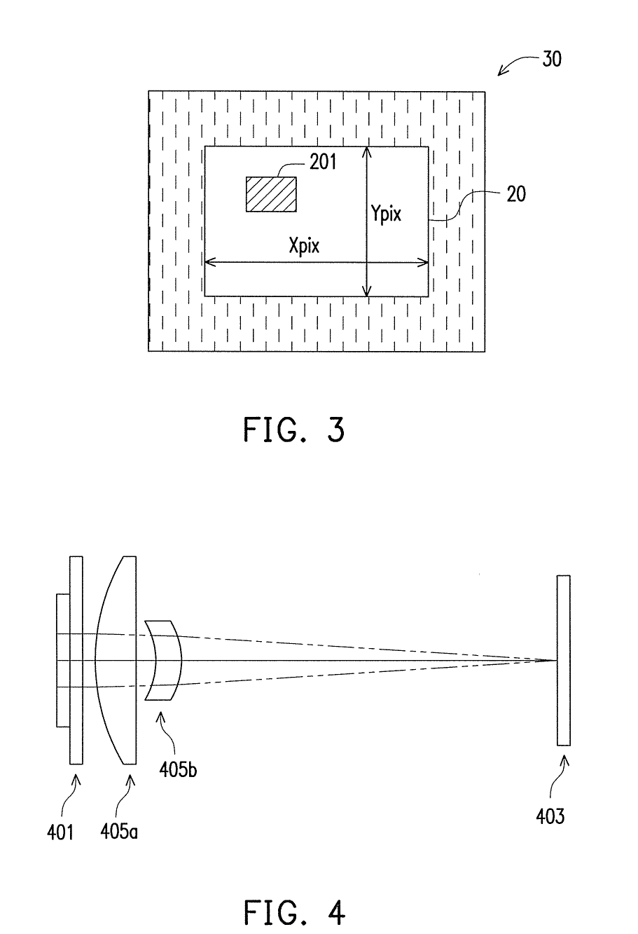

In addition, the image acquisition unit 103 is positioned above the bottom surface Bottom_S of the object 20, and the image acquisition unit 103 is configured for acquiring at least an acquired image 30 of the object 20, an example of which is shown in FIG. 3. The image acquisition unit 103 and the reference surface 101 are separated by a reference distance href. Moreover, as shown in FIG. 3, the image around the object 20 is the image of the reference surface 101.

In this exemplary embodiment, the image acquisition unit 103 has a distance detection function. For the configuration of the image acquisition unit 103 shown in FIG. 4, for example, the image acquisition unit 103 may include a wavefront phase mask 401, an image sensor 403 (e.g., a CCD image sensor or a CMOS image sensor) and two lenses 405a and 405b both disposed between the wavefront phase mask 401 and the image sensor 403. The wavefront phase mask 401 may transform the wavefront according to the following equation 1:

W(x,y)=a(x⁴+y⁴), a=3e⁻⁸mm⁻³ Equation 1.

Moreover, the lenses 405a and 405b are designed to Ruin image(s) on the image sensor 403 at a given effective focal length. It should be appreciated that, the configuration of the image acquisition unit 103 may be adjusted in accordance with design or application requirements.

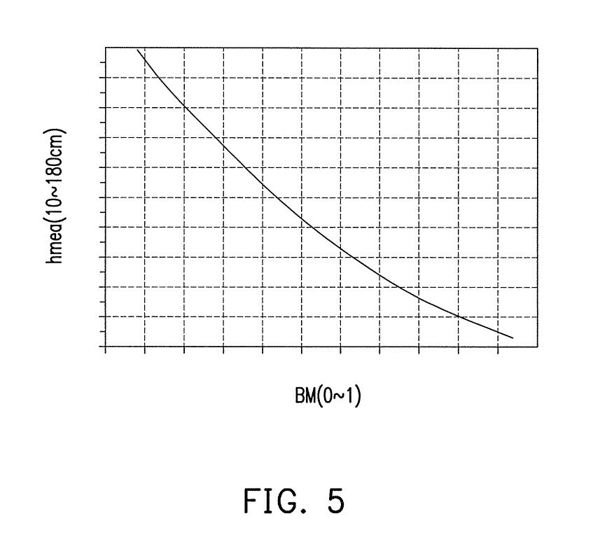

Furthermore, the processing unit 105 is coupled to the image acquisition unit 103. The processing unit 105 is configured for processing the acquired image 30 which may be stored in the memory unit 107 coupled to the processing unit 105. A blur metric (BM) of the image pattern 201 is calculated, and a normalized blur metric value (BM as shown in FIG. 5) is obtained for evaluating a dimension of the object 20 such as a height hp. The image pattern 201 in the acquired image 30 may be obtained by selecting a region of interest in the acquired image 30 using computer vision techniques, for example.

To be specific, the processing unit 105 may obtain the normalized blur metric value BM by firstly comparing a difference between a grayscale information corresponding to the obtained image pattern 201 with the grayscale information convoluted by a point spread function (PSF) of the image acquisition unit 103, and then normalizing the difference. In the present embodiment, the PSF of the image acquisition unit 103 may be represented by the following equation 2:

$$Equation 2$$

$$H ( {f}_{x ,} {f}_{y} ) \frac{{{{\int }_{ }^{ } \int }_{A ( {f}_{x} , {f}_{y} )}}_{ }^{ } {e}^{j k a [ {( x + \frac{λ {zf}_{x}}{2} )}^{4} + {( y + \frac{λ {zf}_{y}}{2} )}^{4} - {( x - \frac{λ {zf}_{x}}{2} )}^{4} - {( y - \frac{λ {zf}_{y}}{2} )}^{4} ]} d x d y}{{\int \int }_{A ( 0 , 0 )} d x d y} .$$

However, the PSF of the image acquisition unit 103 may also be obtained from simulation plots of the image acquisition unit, which may be acquired by using an optical ray tracing software. After the normalized blur metric value BM is obtained from the processing unit 105, the processing unit 105 retrieves a measured distance hmea corresponding to the obtained normalized blur metric value BM from a distance lookup table D-LUT according to the obtained normalized blur metric value BM. The distance lookup table D-LUT may be stored in the memory unit 107, or may be stored in a storage medium externally. The distance lookup table D-LUT includes relationships between a plurality of normalized blur metric values BM and a plurality of measured distances hmea which is from the entrance pupil of the image acquisition unit to the top surface Top_S of the object. However, the measured distance hmea corresponding to the obtained normalized blur metric value BM is not limited to being retrieved from the distance lookup table D-LUT. The measured distance hmea may also be retrieved from an equation input into the memory unit 107, for example, providing directly the relationship between the normalized blur metric and the distance from the entrance pupil of the image acquisition unit to the top surface Top_S of the object.

Once the processing unit 105 retrieves the measured distance hmea corresponding to the obtained normalized blur metric value BM from the distance lookup table D-LUT stored in the memory unit 107, the processing unit 105 subtracts the measured distance hmea from the reference distance href, so as to evaluate the height hp of the object 20 (i.e. hp=href−hmea).

On the other hand, the processing unit 105 may further process the acquired image 30 by using computer vision techniques, for example, to determine an image portion in the acquired image 30 containing the top surface Top_S of the object 20, and to obtain an edge image of the image portion containing the top surface Top_S with an edge detection operation. The edge image facilitates the obtention of a length information Ypix and a width information Xpix corresponding to the top surface Top_S of the object 20, as shown in FIG. 3. It is noted that although the length information Ypix can correspond to a number of pixels counting vertically in the top surface Top_S of the object 20, and the width information Xpix can correspond to a number of pixels counting horizontally in the top surface Top_S of the object 20, the information acquired by detecting the edge of the top surface Top_S in the acquired image 30 are not limited to the length and width information.

After the processing unit 105 obtains the length information Ypix and the width information Xpix corresponding to the top surface Top_S of the object 20, the processing unit 105 determines the magnification ratio M of the image acquisition unit at by using the following equation 3 according to the measured distance hmea. The magnification ratio can be obtained either from an off-line calibration of the image acquisition unit, a polynomial approximation of the form given in equation 3, or it can be obtained from traditional geometrical optics formulae providing the magnification as a function of the distance. Alternatively, it can be obtained by simulating the optical characteristics of the image acquisition unit with a ray tracing software.

M(hmea)=αₙhmeaⁿ⁻¹+αₙ₋₁hmeaⁿ⁻²+ . . . +α₁ Equation 3.

The magnification ratio provides the relationship between the number of pixels or other unit in the image, and a size, dimension or distance in metric, imperial or other unit systems. In the equation 3, the corresponding magnification ratio M(hmea) is the magnification ratio (n cm/pix) at the measured distance hmea, and αₙ, . . . , α₁ are constants.

Accordingly, as shown in FIG. 2B, the processing unit 105 evaluates a length Wy and a width Wx of the object 20 according to the length information Ypix, the width information Xpix, and the corresponding magnification ratio M(hmea). To be specific, the processing unit 105 respectively performs a multiplication operation to the length information Ypix and the width information Xpix according to the corresponding magnification ratio M(hmea), so as to evaluate the length Wy and the width Wx of the object 20, namely,

Wy=Ypix*M(hmea);

Wx=Xpix*M(hmea).

Once the processing unit 105 evaluates the height hp, the length Wy, and the width Wx of the object 20, the processing unit 105 can calculate the volume of the object 20 according the evaluated height hp, length Wy, and width Wx. If the volume of the object 20 is defined as V20, for example, the volume V20=hp*Wy*Wx.

In the present embodiment, the volume of the object 20 can be evaluated in a short period of time using a single image acquisition unit such as a camera. Accordingly, in one application of the apparatus 10, for instance, shipping companies can utilize the most appropriate container or cargo space for each object to deliver, thereby reducing operation costs and optimizing the transportation fleet.

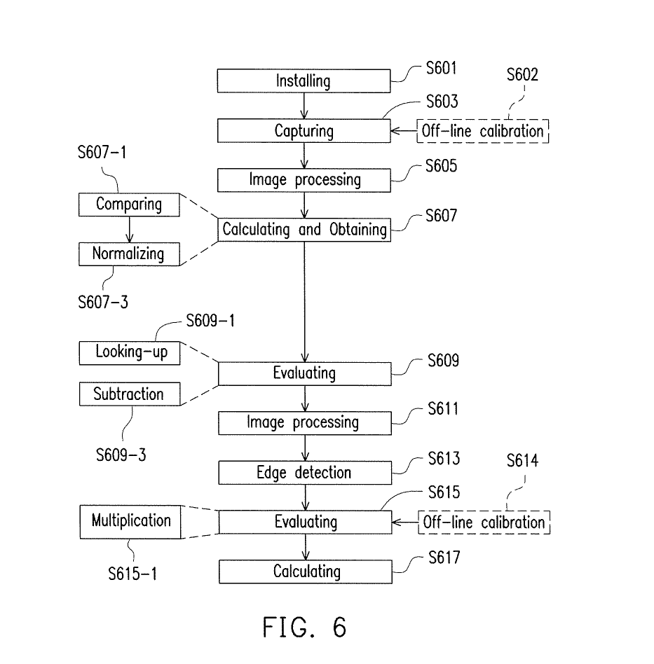

Based on the embodiments described above, FIG. 6 is a flow chart of a method for evaluating a volume of an object according to an exemplary embodiment. Referring to FIG. 6, the method of the exemplary embodiment includes the following steps.

An image acquisition unit is positioned at a reference distance from a bottom surface of the object (Step S601), and the image acquisition unit is configured to acquire at least an image of the object (Step S603). The object may be a parcel, a package, or a product in an assembly line, although the disclosure is not limited thereto. The object may be rested on a reference surface, which can be a conveyor belt, although the object is not limited to being placed on any particular surface in the disclosure. The top surface of the object has an image pattern, such as a 2D barcode (e.g. QR code), but any image patterns having a plurality of elements arranged regularly, randomly, or pseudo-randomly can be used, with the elements having the same size or different size, as long as the elements in the image pattern can be resolved by the image acquisition unit. Moreover, the image acquisition unit has a distance detection function, but the disclosure not limited thereto.

The acquired image is processed in order to calculate a blur metric of an image pattern in the acquired image (Step S605), and to obtain a normalized blur metric value (Step S607) for evaluating a dimension of the object, such as the height (Step S609). The image pattern in the acquired image may be obtained by selecting a region of interest in the acquired image using computer vision techniques, for example.

In Step S607, the normalized blur metric value is obtained by comparing a difference between a grayscale information corresponding to the obtained image pattern with the grayscale information convoluted by a PSF of the image acquisition unit (Step S607-1), and then normalizing the difference (Step S607-3).

In addition, in Step S609, the height of the object is evaluated by retrieving a measured distance corresponding to the normalized blur metric value from a distance lookup table according to the normalized blur metric value, in which the corresponding magnification ratio relates to the measured distance (Step S609-1). Moreover, the measured distance is subtracted from the reference distance, so as to evaluate the height of the object (Step S609-3).

After the height of the object is evaluated, the acquired image is further processed by using computer vision techniques, for example, to determine an image portion in the acquired image containing the top surface of the object (Step S611), and to perform an edge detection operation to the acquired image to acquire the image portion containing the top surface. Accordingly, a length information and a width information corresponding to the top surface of the object are obtained. (Step S613).

After both the length information and the width information are obtained, a length and a width of the object are evaluated according to the length information, the width information and a corresponding magnification ratio (Step S615).

In Step S615, the length and the width of the object are evaluated by respectively performing a multiplication operation to the length information and the width information according to the corresponding magnification ratio (Step S615-1).

After the height, the length, and the width of the object are evaluated, the volume of the object is calculated according the evaluated height, length, the evaluated length and the evaluated width (Step S617).

In this exemplary embodiment, before acquiring the image of the object (Step S603), an off-line calibration can be performed in order to obtain the distance lookup table (Step S602), in which the distance lookup table includes relationships between a plurality of normalized blur metric values and a plurality of measured distances, and the relationships therebetween may be adjusted according to design or application considerations. In addition, before evaluating the length and the width of the object (Step S615), an off-line calibration can be performed to the corresponding magnification ratio according to the measured distance (Step S614).

In an exemplary embodiment, the off-line calibration described in Step S602 results in a calibration curve shown in FIG. 5, which can be a curve of a distance as a function of normalized blur metric values, for example. The calibration curve may be obtained by imaging a pattern placed at various distances from the image acquisition unit, such as from an entrance pupil of a lens in the image acquisition unit, and computing the blur metric of the region of interest corresponding to the pattern.

The pattern used in the off-line calibration of Step S602 may be formed by a plurality of elements of equal or different size. The elements in the pattern may have a distribution following a particular statistical law. The elements with different sizes may also conform to a particular coding pattern such as in a QR or 2D bar code. The pattern may also be formed in accordance to a motif. Moreover, the size of the pattern should be large enough so that a part or whole of the pattern can be imaged by the image acquisition unit The size of the elements constituting the pattern, for example square dots, or circles, should be sufficiently large so that the resolution of the image acquisition unit does not limit the capturing of the details of the elements located within the pattern.

In summary, the apparatus and the method for evaluating the volume of the object according to embodiments of the disclosure can evaluate the volume of the object using a single camera, and the evaluation time is short. Accordingly, shipping companies can utilize the most appropriate container or cargo space for a set of objects to be delivered, thereby reducing operation costs and optimizing the transportation fleet.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An apparatus for evaluating a volume of an object, comprising:
an image acquisition unit positioned at a first distance from a bottom surface of the object and configured for acquiring at least an acquired image of the object; and
a processing unit coupled to the image acquisition unit and configured for processing the acquired image to calculate a blur metric of an image pattern in the acquired image, and to obtain a normalized blur metric value for evaluating a first dimension of the object,
wherein the processing unit further processes the acquired image to determine an image portion of the acquired image, the image portion comprising a top surface of the object, and the processing unit performs an edge detection operation on the image portion to obtain a second dimension information and a third dimension information corresponding to the image portion,
wherein the processing unit evaluates a second dimension and a third dimension of the object according to the second dimension information, and the third dimension information, and a corresponding magnification ratio,
wherein the processing unit calculates the volume of the object according the first dimension, the second dimension, and the third dimension.

2. The apparatus according to claim 1, wherein the processing unit obtains the normalized blur metric value by comparing a difference between a grayscale information corresponding to the image pattern with the grayscale information convoluted by a point spread function of the image acquisition unit, and then normalizing the difference.

3. The apparatus according to claim 1, wherein
the processing unit retrieves a second distance corresponding to the normalized blur metric value from a distance lookup table according to the normalized blur metric value, wherein the corresponding magnification ratio relates to the second distance; and
the processing unit subtracts the second distance from the first distance, so as to evaluate the first dimension of the object.

4. The apparatus according to claim 1, further comprising:
a memory unit coupled to the processing unit and configured for storing a distance lookup table.

5. The apparatus according to claim 4, wherein the memory unit is further configured for storing the acquired image.

6. The apparatus according to claim 1, wherein the processing unit respectively performs a multiplication operation to the second dimension information and the third dimension information according to the corresponding magnification ratio, so as to evaluate the second dimension and the third dimension of the object.

7. The apparatus according to claim 1, wherein the image acquisition unit comprises:
a wavefront phase mask;
an image sensor; and
at least one lens disposed between the wavefront phase mask and the image sensor.

8. The apparatus according to claim 7, wherein the image sensor comprises a charge coupled device (CCD) image sensor or a complementary metal-oxide semiconductor (CMOS) image sensor.

9. The apparatus according to claim 1, wherein the image acquisition unit processes the acquired image by using a computer vision technique.

10. The apparatus according to claim 1, wherein the image pattern comprises a 2D barcode.

11. The apparatus according to claim 1, wherein the image pattern comprises a QR code.

12. The apparatus according to claim 1, wherein the object rests on a reference surface.

13. The apparatus according to claim 1, wherein the object at least comprises a parcel.

14. A method for evaluating a volume of an object, comprising:
positioning an image acquisition unit at a first distance from a bottom surface of the object and configuring the image acquisition unit to acquire at least an acquired image of the object;
processing the acquired image to calculate a blur metric of an image pattern in the acquired image, and to obtain a normalized blur metric value for evaluating a first dimension of the object;
processing the acquired image to determine an image portion of the acquired image, the image portion comprising a top surface of the object, and performing an edge detection operation on the image portion to obtain a second dimension information and a third dimension information corresponding to the image portion;
evaluating a second dimension and a third dimension of the object according to the second dimension information, the third dimension information, and a corresponding magnification ratio; and
calculating the volume of the object according the first dimension, the second dimension, and the third dimension.

15. The method according to claim 14, wherein the normalized blur metric value is obtained by:
comparing a difference between a grayscale information corresponding to the image pattern with the grayscale information convoluted by a point spread function of the image acquisition unit; and
normalizing the difference.

16. The method according to claim 14, wherein the first dimension of the object is evaluated by:
retrieving a second distance corresponding to the normalized blur metric value from a distance lookup table according to the normalized blur metric value, wherein the corresponding magnification ratio relates to the second distance; and
subtracting the second distance from the first distance to obtain the first dimension of the object.

17. The method according to claim 16, wherein before acquiring the acquired image of the object, the method further comprises:
performing an off-line calibration process to obtain the distance lookup table.

18. The method according to claim 14, wherein the second dimension and the third dimension of the object are evaluated by:
respectively performing a multiplication operation to the second dimension information and the third dimension information according to the corresponding magnification ratio.

19. The method according to claim 16, wherein before evaluating the second dimension and the third dimension of the object, the method further comprises:
performing an off-line calibration process to the corresponding magnification ratio according to the second distance.

20. The method according to claim 14, wherein the image acquisition unit is implemented by a camera having a distance detection function.

21. The method according to claim 14, wherein the acquired image is processed by using a computer vision technique.

22. The method according to claim 14, wherein the image pattern comprises a 2D barcode.

23. The method according to claim 22, wherein the 2D barcode at least comprises a QR code.
